(19) United States
(12) Patent Application Publication
(10) Pub. No.: US 2015/0218403 A1
(43) Pub. Date: Aug. 6, 2015

(54) INTUMESCENT CAULKING COMPOSITIONS AND METHODS

(71) Applicant: 3M INNOVATIVE PROPERTIES COMPANY, St. Paul, MN (US)

(72) Inventors: Yi Lu, St. Paul, MN (US); Eumi Pyun, Austin, TX (US); Carl E. Fisher, Austin, TX (US); Jimmie R. Baran, Jr., Prescott, WI (US); Robert E. Gestner, West St. Paul, MN (US); Terrance P. Smith, Woodbury, MN (US)

(73) Assignee: 3M INNOVATIVE PROPERTIES COMPANY, St. Paul, MN (US)

(21) Appl. No.: 14/171,530

(22) Filed: Feb. 3, 2014

(51) Int. Cl. C09D 131/04; C08K 5/52; C08K 3/04

(52) U.S. Cl. CPC C09D 131/04; C08K 3/04; C08K 5/52

(57) ABSTRACT

Embodiments herein include intumescent caulking compositions and methods related thereto. In an embodiment, an intumescent caulking composition is included having a nitrogen phosphorus component and an expandable graphite. The composition can exhibit a char expansion ratio of at least 8, a char strength of at least 8 N, and a caulk rate of greater than 100 gm/min after 1 day. In an embodiment, an intumescent caulking composition is included having at least about 5 wt. % ethylene diamine phosphate, at least about 5 wt. % expandable graphite, and at least about 30 wt. % of an elastomeric binder. In an embodiment, a method of making an intumescent caulking composition is included. In an embodiment, a method of using an intumescent caulking composition is included. In an embodiment, a method of enhancing the fire retardancy of a wall or floor is included. Other embodiments are also included herein.

### BACKGROUND

During the construction of buildings, it is often necessary to provide openings or passages (often referred to as through-penetrations) through the building floors, walls, and ceilings to permit the running of pipes, wires, cables, and the like. Unfortunately, such through-penetrations may provide a mechanism by which fire and smoke may spread from one compartment of a building to another. Thus, it is common to “firestop” such through-penetrations by providing, within the through-penetration, intumescent firestop materials which, upon exposure to sufficiently high temperature, can expand to close off the through-penetration. In one approach, a firestop material is placed in the through-penetration after the formation of the through-penetration and/or placement of a pipe or other object through the through-penetration.

### SUMMARY

Embodiments herein include intumescent caulking compositions and methods related thereto. In an embodiment, an intumescent caulking composition is included having a nitrogen phosphorus component and an expandable graphite. The composition can exhibit a char expansion ratio of at least 8, a char strength of at least 8 N, and a caulk rate of greater than 100 gm/min after 1 day.

In an embodiment, an intumescent caulking composition is included having at least about 5 wt. % ethylene diamine phosphate, at least about 5 wt. % expandable graphite, and at least about 30 wt. % of an elastomeric binder.

In an embodiment, a method of making an intumescent caulking composition is included. The method can include mixing together components including at least about 5 wt. % ethylene diamine phosphate; at least about 5 wt. % expandable graphite; and at least about 30 wt. % of an elastomeric binder to form the intumescent caulking composition.

In an embodiment, a method of using an intumescent caulking composition is included. The method can include applying the intumescent caulking composition to a surface. The intumescent caulking composition can include at least about 5 wt. % ethylene diamine phosphate, at least about 5 wt. % expandable graphite, and at least about 30 wt. % of an elastomeric binder.

In an embodiment, a method of enhancing the fire retardancy of a wall or floor included. The method can include preparing an intumescent caulking composition by mixing a nitrogen phosphorus component, an expandable graphite, and an elastomeric binder together. The method can further include applying the intumescent caulking composition to openings through a wall or a floor and allowing the intumescent caulking composition to dry.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense.

### BRIEF DESCRIPTION OF THE DRAWINGS

Embodiments may be more completely understood in connection with the following drawings, in which:

FIG. 1 is a graph showing char strength versus char expansion ratio for various compositions herein.

FIG. 2 is a graph showing char strength versus char expansion ratio for various compositions herein.

FIG. 3 is a graph showing char strength versus char expansion ratio for various compositions herein.

FIG. 4 is a graph showing char strength versus char expansion ratio for various compositions herein.

While embodiments herein susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

Embodiments herein can include an intumescent caulking composition exhibiting various desirable properties. The caulking composition can include a nitrogen phosphorus component and an expandable graphite. Properties of the intumescent caulking applications can include a desirable char expansion ratio (or intumescent volume expansion ratio) and a desirable char strength. As such, intumescent caulking compositions in accordance with embodiments herein have many applications including, but not limited to, as construction materials to enhance fire safety. In addition, intumescent compositions herein can be formed without organic solvents. The lack of organic solvents can be advantageous for a variety of reasons including, in some scenarios, reducing fumes associated with organic solvent outgassing and enhancing the speed with which the material can be cured.

The char expansion ratio is a measure of how much the composition expands as a result of exposure to a heated environment, such as a fire. In some embodiments the composition can exhibit a char expansion ratio of at least 8 (as measured after exposure to conditions to create char such as described in the examples below). In some embodiments the char expansion ratio can be at least 10. In some embodiments the char expansion ratio can be at least 12. In some embodiments the char expansion ratio can be at least 15. In some embodiments the char expansion ratio can be at least 20.

Char strength is a measure of strength retained by the remaining char after the composition has been exposed to a heated environment, such as a fire. In some embodiments the composition (as measured after exposure to conditions to create char such as described in the examples below) can exhibit a char strength of at least 8 N. In some embodiments the composition can exhibit a char strength of at least 10 N. In some embodiments the composition can exhibit a char strength of at least 12 N. In some embodiments the composition can exhibit a char strength of at least 15 N. In some embodiments the composition can exhibit a char strength of at least 20 N.

As a caulking composition, embodiments can be sufficiently flowable for application. By way of example, some embodiments can exhibit a caulk rate of greater than 100 gm/min after 1 day. Caulk rate can be measured in accordance with ASTM C1183. By way of example, some embodiments can exhibit a caulk rate of greater than 150 gm/min after 1 day. By way of example, some embodiments can exhibit a caulk rate of greater than 200 gm/min after 1 day. By way of example, some embodiments can exhibit a caulk rate of greater than 250 gm/min after 1 day. By way of example, some embodiments can exhibit a caulk rate of greater than 300 gm/min after 1 day. By way of example, some embodiments can exhibit a caulk rate of greater than 350 gm/min after 1 day. By way of example, some embodiments can exhibit a caulk rate of greater than 400 gm/min after 1 day.

The Boeing flow (or slump) of the intumescent caulking composition can be less than about 4.0 in units of inches after 1 day. Boeing flow can be measured in accordance with ASTM D2202. In some embodiments, the Boeing flow can be less than or equal to about 3.0 inches after 1 day. In some embodiments, the Boeing flow can be less than or equal to about 2.0 inches after 1 day. In some embodiments, the Boeing flow can be less than or equal to about 1.5 inches after 1 day. In some embodiments, the Boeing flow can be less than or equal to about 1.2 inches after 1 day.

In various embodiments herein, the composition includes a nitrogen phosphorus component that can include one or more nitrogen phosphorus compounds. Nitrogen phosphorus compounds can include a nitrogen containing group such as an amine, ammonium, or the like and a phosphorus containing group such as a phosphate, pyrophosphate, polyphosphate, phosphonate, or the like. Examples of nitrogen phosphorus compounds can include, but are not limited to, polyammonium phosphates, ammonium polyphosphates, ammonium hydrogenphosphates, ammonium trihydrazinophosphates, melamine phosphates, melamine pyrophosphates, melamine polyphosphates, guanidine phosphates, ethylene diamine phosphate, ethylenediammonium phosphate, and the like. In some particular embodiments, the nitrogen phosphorus compound is ethylene diamine phosphate. In some embodiments, the nitrogen phosphorus compound can include a mixture of compounds. In some embodiments, the composition can include a first nitrogen containing compound and a second phosphorus containing compound.

Nitrogen-phosphorous compounds can include those known under the trade designation “INTUMAX AC-3” and “INTUMAX AC-3 WM”, from Broadview Technologies, Inc., Newark, N.J.; “UNIPLEX FRX44-94S” from Unitex Chemical Corp., Greensboro, N.C.; “NH 1197”, from Great Lakes Chemical Corp., West Lafayette Ind.; “Amgard ND” “Arngard EDAP” “Amgard NH” from Albright and Wilson, Richmond, Va.; and “Exolet IFR-10”, Hoechst Celanese Corp. Somerset, N.J.

Exemplary nitrogen phosphorus compounds are described in U.S. Pat. No. 6,733,697 content of which is herein incorporated by reference.

The nitrogen phosphorus compound(s) can be part of the intumescent caulking composition in various amounts. In some embodiments, the composition includes at least about 5 wt. % of the nitrogen phosphorus component. In some embodiments, the composition includes at least about 10 wt. % of the nitrogen phosphorus component. In some embodiments, the composition includes at least about 15 wt. % of the nitrogen phosphorus component. In some embodiments, the composition includes at least about 20 wt. % of the nitrogen phosphorus component. In some embodiments, the composition includes at least about 25 wt. % of the nitrogen phosphorus component. In some embodiments, the composition includes at least about 30 wt. % of the nitrogen phosphorus component. In some embodiments, the composition includes at least about 35 wt. % of the nitrogen phosphorus component. In some embodiments, the composition includes at least about 40 wt. % of the nitrogen phosphorus component. In some embodiments, the composition includes at least about 45 wt. % of the nitrogen phosphorus component.

In some embodiments, the composition includes less than about 50 wt. % of the nitrogen phosphorus component. In some embodiments, the composition includes less than about 45 wt. % of the nitrogen phosphorus component. In some embodiments, the composition includes less than about 40 wt. % of the nitrogen phosphorus component. In some embodiments, the composition includes less than about 35 wt. % of the nitrogen phosphorus component. In some embodiments, the composition includes less than about 30 wt. % of the nitrogen phosphorus component. In some embodiments, the composition includes less than about 25 wt. % of the nitrogen phosphorus component. In some embodiments, the composition includes less than about 20 wt. % of the nitrogen phosphorus component. In some embodiments, the composition includes less than about 15 wt. % of the nitrogen phosphorus component.

In some embodiments, the composition includes the nitrogen phosphorus component in an amount that ranges between any of the lower and upper bounds described above. By way of example, the composition can include the nitrogen phosphorus component in an amount from about 5 wt. % to about 50 wt. %. In some embodiments, the composition can include the nitrogen phosphorus component in an amount from about 5 wt. % to about 45 wt. %. %. In some embodiments, the composition can include the nitrogen phosphorus component in an amount from about 10 wt. % to about 40 wt. %. In some embodiments, the composition can include the nitrogen phosphorus component in an amount from about 5 wt. % to about 15 wt. %. In some embodiments, the composition can include the nitrogen phosphorus component in an amount from about 25 wt. % to about 45 wt. %.

In various embodiments herein, the composition can include an intumescent agent. Intumescent agents can include, but are not limited to, those agents that expand when heated such as in the case of a fire. Intumescent agents can include, but are not limited to, expandable graphite, vermiculite, mica, borax, sodium silicate, and the like.

In particular embodiments, the intumescent agent can be an expandable graphite (or intumescent flake graphite). Expandable graphites are graphites in which the interstitial layers contain chemical groups (for example sulfuric acid) which lead to thermal expansion. Expandable graphites can include nitrosated, oxidised and halogenated graphites. Many expandable graphites typically expand when in a temperature range of from 80° C. to 250° C. or more. However, graphites with other expansion temperatures can be included.

Examples of expandable graphite can include those known under the trade designation “NYAGRAPH 351”, from Nyacol Nano Technologies, Inc., Ashland, Mass.; “GRAFGUARD 160N”, from GrafTech, Intl, Holdings, Inc., Lakewood, Ohio; and “ASBURY 3772”, from Asbury Graphite & Carbons NL B.V., Maastricht, Netherlands.

The expandable graphite can be part of the intumescent caulking composition in various amounts. In some embodiments, the composition includes at least about 5 wt. % of the expandable graphite. In some embodiments, the composition includes at least about 10 wt. % of the expandable graphite. In some embodiments, the composition includes at least about 15 wt. % of the expandable graphite. In some embodiments, the composition includes at least about 20 wt. % of the expandable graphite. In some embodiments, the composition includes at least about 25 wt. % of the expandable graphite. In some embodiments, the composition includes at least about 30 wt. % of the expandable graphite. In some embodiments, the composition includes at least about 35 wt. % of the expandable graphite. In some embodiments, the composition includes at least about 40 wt. % of the expandable graphite. In some embodiments, the composition includes at least about 45 wt. % of the expandable graphite.

In some embodiments, the composition includes less than about 50 wt. % of the expandable graphite. In some embodiments, the composition includes less than about 45 wt. % of the expandable graphite. In some embodiments, the composition includes less than about 40 wt. % of the expandable graphite. In some embodiments, the composition includes less than about 35 wt. % of the expandable graphite. In some embodiments, the composition includes less than about 30 wt. % of the expandable graphite. In some embodiments, the composition includes less than about 25 wt. % of the expandable graphite. In some embodiments, the composition includes less than about 20 wt. % of the expandable graphite. In some embodiments, the composition includes less than about 15 wt. % of the expandable graphite.

In some embodiments, the composition includes the expandable graphite in an amount that ranges between any of the lower and upper bounds described above. By way of example, the composition can include the expandable graphite in an amount from about 5 wt. % to about 50 wt. %. In some embodiments, the composition can include the expandable graphite in an amount from about 5 wt. % to about 45 wt. %. %. In some embodiments, the composition can include the expandable graphite in an amount from about 10 wt. % to about 40 wt. %. In some embodiments, the composition can include the expandable graphite in an amount from about 5 wt. % to about 15 wt. %. In some embodiments, the composition can include the expandable graphite in an amount from about 25 wt. % to about 45 wt. %.

In various embodiments herein, the composition can include an elastomeric binder material. It will be appreciated that there are various elastomeric binders which can be used. Elastomeric binders can include aqueous and non-aqueous elastomeric binder compositions. Aqueous elastomeric binders can include compositions including polymers in an aqueous solution. Non-aqueous elastomeric binders can include compositions including polymers in a solution with an organic solvent.

In some embodiments, the elastomeric binder is a latex binder. Latex binders are an example of an aqueous elastomeric binder. There are many latexes which are suitable. One example of a latex is a halogenated latex, such as a polychloroprene latex. When the latex includes polychloroprene, the intumescent caulking composition can include an HCl scavenger such as zinc oxide

Another group of latexes which can be used are non-halogenated latexes. Examples of non-halogenated latexes generally include acrylate polymers, natural rubbers, styrene butadiene copolymers, butadiene acrylonitrile copolymers, polyisoprene, and polybutadiene.

Latexes can include the ethylene/vinyl acetate; acrylate terpolymer latex “Vinnepas 600 BP”, commercially available from commercially available from Wacker Chemie, AG, the ethylene/vinyl acetate/acrylate terpolymer latex “EAF 68”, commercially available from Wacker Chemie, AG, the acrylate polymer latex “Rhoplex HA-8”, commercially available from Rohm and Haas Co., “Flexbond 153” and “Flexbond 149”, commercially available from Air Products and Chemicals.

It will be appreciated that various other components can be included herein. By way of example, a flame retardant can also be included. Flame retardants can include, but are not limited to, phosphorus compounds, glass frit compounds, boron compounds, alumina trihydrate, antimony oxides, other metal oxides and hydrates, alkyl phosphates (such as alkyl phosphate oligomer—CAS No. 184538-58-7—sold under the trade name FYROL PNX, available from ICL Industrial Products).

The latex can also include other additives including, e.g., hydrochloric acid scavenger (e.g., zinc oxide), surfactants, dispersants, defoamers and antioxidants. In addition, coloring agents can be included. Coloring agents can include, but are not limited to, iron oxide. Surfactants can also be included. An exemplary class of non-ionic surfactants is alcohol ethoxylates. These are either in the form of linear alcohol ethoxylates or secondary alcohol ethoxylates. Common trade names include “Neodol”, available from Shell Chemicals, “Tergitol” available from The Dow Chemical Company, “Tomadol” available from Air Products and Chemicals, Inc. These are characterized by having alkyl chain having 8-18 carbons and moles of ethoxylation from 3-40. An exemplary rheology modifier is polyethylene glycol. These glycols provide excellent rheology modification using molecular weights from as low as 100 to greater than 6000. These are sold under the trade names “CARBOWAX”, available from The Dow Chemical Company and “Renex” available from Croda. Other components can include, but are not limited to, fiberglass and fumed silica.

It will be appreciated that various other components can be included with compositions herein. In some embodiments, the intumescent caulking composition can further include a silica material. In some embodiments, the silica material can be a nanosilica. While not intending to be bound by theory, it is believed that the incorporation of the silica material can expand the expansion ratio and allow for components of the intumescent caulking composition mix in more uniformly.

The silica material can have various particle sizes. In some embodiments, the particle size is from about 1 to about 50 nm. In some embodiments, the particle size is from about 1 to about 10 nm. In some embodiments, the particle size is about 5 nm.

The silica material can be incorporated at various amounts. In some embodiments, the intumescent caulking composition can include from about 0.01 wt. % to about 10.0 wt. % of a silica material. In some embodiments, the intumescent caulking composition can include from about 0.01 wt. % to about 8.0 wt. % of a silica material. In an embodiment, the intumescent caulking composition can include from about 0.1 wt. % to about 5.0 wt. % of a silica material. In an embodiment, the intumescent caulking composition can include from about 0.1 wt. % to about 0.5 wt. % of a silica material.

In some embodiments an endothermic agent can be included. Endothermic agents can include, but are not limited to, alumina trihydrate, hydrated zinc borate, hydrated magnesium oxide, and the like.

In some embodiments, additional char strengtheners can be included. Char strengtheners can include, but are not limited to, low-melting glasses, pentaerythritol, and the like.

The weight percent solids in the intumescent caulking composition can vary. In some embodiments, the percent solids can be from about 60% solids to about 90% solids. In some embodiments, the percent solids can be from about 70% solids to about 84% solids. In some embodiments, the percent solids can be from about 74% solids to about 80% solids. In some embodiments, the percent solids can be from about 76% solids to about 78% solids.

In some embodiments, a method of making an intumescent caulking composition is included. The method can include mixing or blending together components of a caulking composition, such as those described above. As a specific example, the method can include mixing together at least about 5 wt. % ethylene diamine phosphate, at least about 5 wt. % expandable graphite; and at least about 30 wt. % of a elastomeric binder to form the intumescent caulking composition. The method can further include filling a container (such as a container to dispense the caulking composition from) with the intumescent caulking composition.

In some embodiments, a method of using an intumescent caulking composition is included. The method can include applying the intumescent caulking composition to a surface. The surface can be a surface of various objects or articles. The surface can be, for example, the surface of a substrate. The surface can be one or more sides of a through penetration. The surface can be one or more sides of an aperture. The surface can be a surface of a pipe. It will be appreciated that the surface can be a surface of many different things.

The intumescent caulking composition used in the method can include various components such as those described above. As a specific example, the intumescent caulking composition can include at least about 5 wt. % ethylene diamine phosphate, at least about 5 wt. % expandable graphite, and at least about 30 wt. % of a elastomeric binder.

In some embodiments, a method of enhancing the fire retardancy of a wall or floor is included. The method can include preparing an intumescent caulking composition by mixing a nitrogen phosphorus component, an expandable graphite, and an elastomeric binder together. The method can further include applying the intumescent caulking composition to openings through the wall or floor. The method can further include allowing the intumescent caulking composition to dry.

The embodiments described herein are not intended to be exhaustive or to limit to the precise forms disclosed in the following detailed description. Rather, the embodiments are chosen and described so that others skilled in the art can appreciate and understand the principles and practices of the subject matter described herein.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

The following examples are intended to be representative of specific embodiments, and are not intended as limiting the scope of that described herein.

### EXAMPLES

### Materials

Materials used in the following examples included the following:

| Name | Description |
|---|---|
| EDAP1 | Activated ethylene diamine phosphate, as described in U.S. Pat. No. |
| | 6,733,697, (INTUMAX AC-3, available from Broadview Technologies, Inc., |
| | Newark, N.J.) |
| EDAP2 | Activated ethylene diamine phosphate and melamine phosphate (INTUMAX |
| | AC-3 WM, available from Broadview Technologies, Inc., Newark, N.J.) |
| EDAP3 | Ethylene diamine phosphate (UNIPLEX FRX44-94S, available from Unitex |
| | Chemical Corp., Greensboro, N.C.) |
| APO | Alkyl phosphate oligomer (FYROL PNX, CAS No. 184538-58-7, available |
| | from ICL Industrial Products). |
| Graphite1 | Expandable graphite (NYAGRAPH 351, available from Nyacol Nano |
| | Technologies, Inc., Ashland, MA) |
| Graphite2 | Expandable graphite (GRAFGUARD 160N, available from GrafTech, Int'l, |
| | Holdings, Inc., Lakewood, OH) |
| Graphite3 | Expandable graphite (ASBURY 3772, available from Asbury Graphite & |
| | Carbons NL B.V., Maastricht, Netherlands) |
| ATH | Alumina trihydrate and magnesium hydroxide (HYMOD M916 SG, |
| | available from J. M. Huber Corporation, Atlanta, GA) |
| PHOSLITE | Phosphorus based halogen free flame retardant with 36% phosphorus |
| | content (PHOSLITE B85AX, available from Italmatch Chemicals) |
| MC | Melamine cyanurate (BUDIT 315, CAS No. 37640-57-6) |
| Latex 1 | Ethylene/vinyl acetate/acrylate terpolymer latex (VINNEPAS 600 BP″, |
| | commercially available from commercially available from Wacker Chemie, |
| | AG) |
| Surfactant | Non-ionic surfactant |
| PEG | Polyethylene glycol (300 g/mole) |

### Latex Binder Stock Composition

A latex binder stock composition was prepared for use in the examples herein. The latex binder stock was formed by blending 86.6 wt. % “Latex1”; 1.9 wt. % Surfactant; 4.8 wt. % iron oxide; 2.6 wt. % fiberglass (wet chopped bundled 3 to 5 mm in length), and 4.2 wt. % PEG (300 grams/mole). However, it will be appreciated that references to the wt. % of an elastomeric binder as used herein and for purposes of the claims refer to the actual binder portion and not to the added portions of surfactant, iron oxide, fiberglass, and polyethylene glycol that were combined with the binder and used to make this stock composition.

### Testing Methods

25 mm×25 mm×7 mm coupons of the caulk were formed and dried for at least one week at 50° C. These coupons were exposed to the heat of a 600° C. furnace for one hour after being placed inside of a 25 mm×25 mm×70 mm cup (and were therefore constrained by the sides and bottom of the cup).

After removal from the oven and cup, the expansion ratio of the resulting char was measured. Specifically, the vertical height of the char after the heat exposure was compared with the starting thickness of the coupon. Char that fell out of the cup or was blown away during oven removal was ignored for purposes of the expansion measurement.

The strength of the char was measured using an Instron tensile testing machine fitted with a char-break testing fixture. The char-break testing fixture was an aluminum blade, 1.5 mm wide×100 mm long×25 mm tall. The char was removed from the cup and turned on its side. At a point approximately 15 mm above the bottom, the aluminum blade was pushed vertically downward through the char at 3 mm/min. The maximum load was recorded during the traverse.

Caulk rate can be measured in accordance with ASTM C1183. In some cases variations can be made to the procedure of ASTM C1183 including setting extrusion pressure to 344 kPa±7 kPA (50±1 PSI); extrusion time to 5 seconds; and test temperature to 75±5° F. with ambient humidity. Boeing flow can be measured in accordance with ASTM D2202. In some cases variations can be made to the procedure of ASTM D2202 including using a test jig washer that is 2.5″ in diameter; using a test temperature of 75±5° F. and ambient humidity; advancing the plunger to the fullest extent, flush with the test jig at the start of the test; and measuring the maximum point of flow at 5 minutes.

### Example 1

The following ingredients (see Table 1 below) were mixed into a mixer (Kitchen Aid standard mixer) with continuous mixing for about 20 minutes at room temperature. The remainder of the composition was the latex binder stock composition referenced above.

TABLE 1

| Sample | | | | |
|---|---|---|---|---|
| ID | EDAP1 | Graphite1 | Graphite3 | ATH |
| A | 40% | 10% | 0% | 0% |
| B | 30% | 15% | 0% | 0% |
| C | 30% | 15% | 0% | 5% |
| D | 20% | 8% | 0% | 10% |
| E | 20% | 0% | 8% | 10% |
| F | 10% | 40% | 0% | 0% |
| G | 10% | 40% | 0% | 0% |

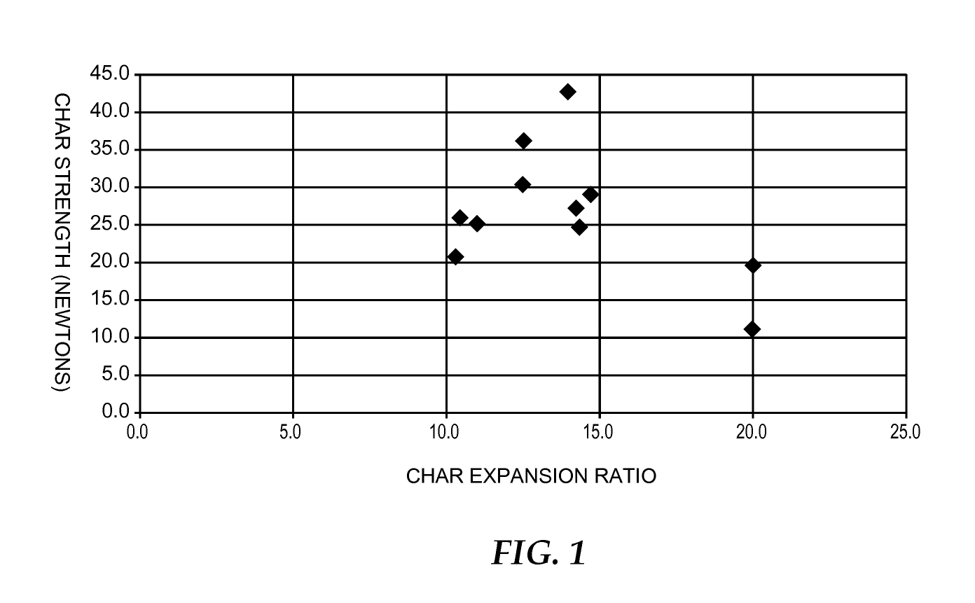

The resulting mixtures were tested according to the methods described above and found to have expansion factors and char strengths as shown in Table 2 below (wherein A1 and A2 represent separate trials of the “A” composition and the same holds true for compositions B, C, and D and wherein * indicates samples that had substantial expanded height but were difficult to measure due to their shape—thus the expansion ratio for those represents an estimate) and in FIG. 1.

TABLE 2

| | Dry | Expanded | | Char |
|---|---|---|---|---|
| Sample | Thickness | Height | Expansion | Strength |
| ID | (mm) | (mm) | Ratio | (N) |
| A1 | 6.8 | 85 | 12.5 | 30.2 |
| A2 | 6.8 | 85 | 12.5 | 36.3 |
| B1 | 6.8 | 95 | 14.0 | 42.8 |
| B2 | 6 | 86 | 14.3 | 24.8 |
| C1 | 6.8 | 97 | 14.3 | 27.2 |
| C2 | 6.8 | 100 | 14.7 | 29.0 |
| D1 | 6.3 | 66 | 10.5 | 25.9 |
| D2 | 6.1 | 67 | 11.0 | 25.0 |
| E | 6.1 | 63 | 10.3 | 20.8 |
| F | 7.6 | * | >20.0 | 19.7 |
| G | 7.6 | * | >20.0 | 11.3 |

### Example 2

The following ingredients (see Table 3 below) were mixed into a paddle-type mixer (Kitchen Aid standard mixer) with continuous mixing for about 20 minutes at room temperature. The remainder of the composition was the latex binder stock composition referenced above.

TABLE 3

| Sample | | | | |
|---|---|---|---|---|
| ID | EDAP3 | Graphite1 | Graphite2 | ATH |
| H | 50% | 8% | 0% | 5% |
| I | 50% | 0% | 8% | 0% |
| J | 40% | 0% | 9% | 0% |
| K | 30% | 8% | 0% | 5% |
| L | 30% | 8% | 0% | 15% |
| M | 30% | 8% | 0% | 10% |
| N | 20% | 8% | 0% | 10% |
| O | 20% | 8% | 0% | 10% |
| P | 20% | 8% | 0% | 10% |
| Q | 20% | 8% | 0% | 10% |
| R | 10% | 30% | 0% | 10% |
| S | 10% | 8% | 0% | 5% |
| T | 10% | 8% | 0% | 15% |
| U | 5% | 50% | 0% | 0% |

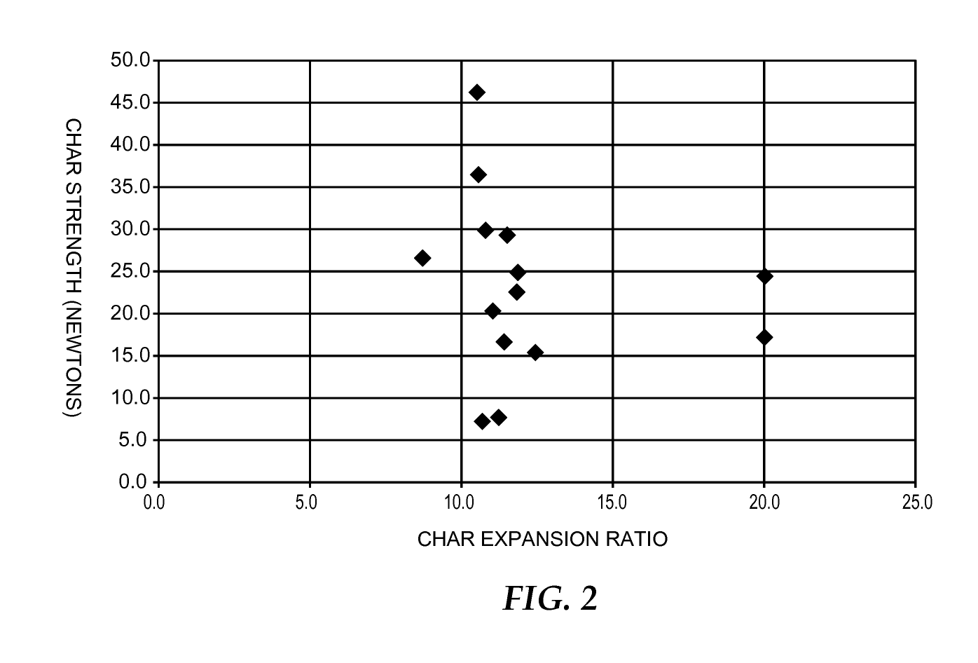

The resulting mixtures were tested according to the methods described above and found to have expansion factors and char strengths as shown in Table 4 below (wherein * indicates samples that had substantial expanded height but were difficult to measure due to their shape—thus the expansion ratio for those represents an estimate) and in FIG. 2.

TABLE 4

| | Dry | Expanded | | Char |
|---|---|---|---|---|
| Sample | Thickness | Height | Expansion | Strength |
| ID | (mm) | (mm) | Ratio | (N) |
| H | 8 | 84 | 10.5 | 46.1 |
| I | 7.6 | 82 | 10.8 | 29.7 |
| J | 6.5 | 77 | 11.8 | 22.5 |
| K | 6.5 | 75 | 11.5 | 29.3 |
| L | 7 | 74 | 10.6 | 36.5 |
| M | 7 | 61 | 8.7 | 26.5 |
| N | 5.8 | 72 | 12.4 | 15.5 |
| O | 6.1 | 67 | 11.0 | 20.2 |
| P | 6.4 | 73 | 11.4 | 16.7 |
| Q | 5.5 | 65 | 11.8 | 25.0 |
| R | 6.5 | * | >20.0 | 24.4 |
| S | 5.6 | 60 | 10.7 | 7.2 |
| T | 6.5 | 73 | 11.2 | 7.6 |
| U | 7.5 | * | >20.0 | 17.2 |

### Example 3

The following ingredients (see Table 5 below) were mixed into a paddle-type mixer (Kitchen Aid standard mixer) with continuous mixing for about 20 minutes at room temperature. The remainder of the composition was the latex binder stock composition referenced above.

TABLE 5

| Sample | | | |
|---|---|---|---|
| ID | EDAP2 | Graphite1 | ATH |
| V | 20% | 8% | 10% |
| W | 20% | 8% | 10% |

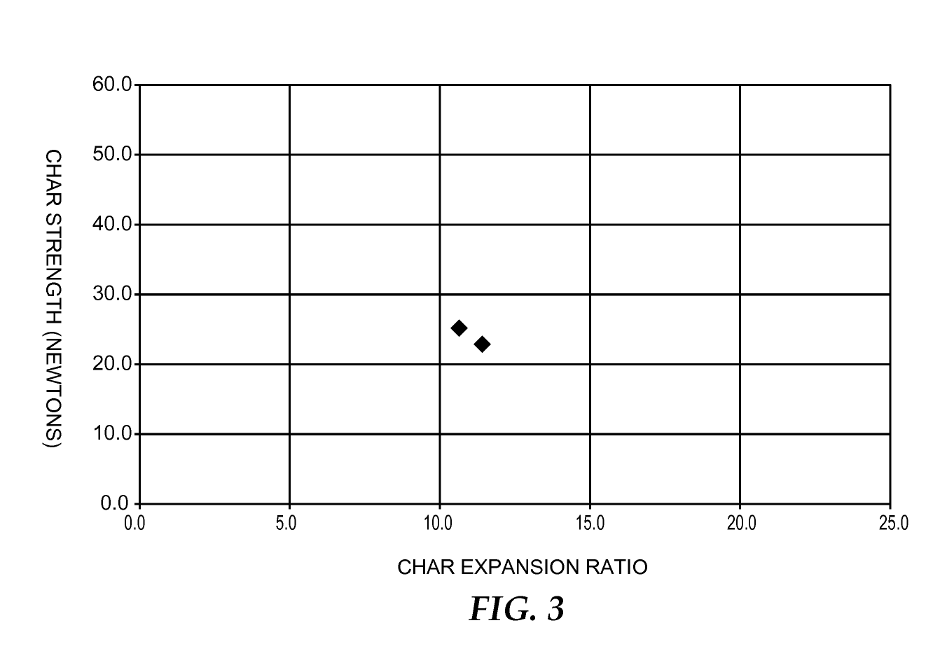

The resulting mixtures were tested according to the methods described above and found to have expansion factors and char strengths as shown in Table 6 below and in FIG. 3.

TABLE 6

| | Dry | Expanded | | Char |
|---|---|---|---|---|
| Sample | Thickness | Height | Expansion | Strength |
| ID | (mm) | (mm) | Ratio | (N) |
| V | 6.3 | 67 | 10.6 | 25.3 |
| W | 6.4 | 73 | 11.4 | 23.0 |

### Example 4

The following ingredients (see Table 7 below) were mixed into a paddle-type mixer (Kitchen Aid standard mixer) with continuous mixing for about 20 minutes at room temperature. The remainder of the composition was the latex binder stock composition referenced above.

TABLE 7

| Sample | | | | |
|---|---|---|---|---|
| ID | PHOSLITE | MC | Graphite1 | ATH |
| X | 9% | 11% | 8% | 10% |
| Y | 0% | 0% | 8% | 30% |

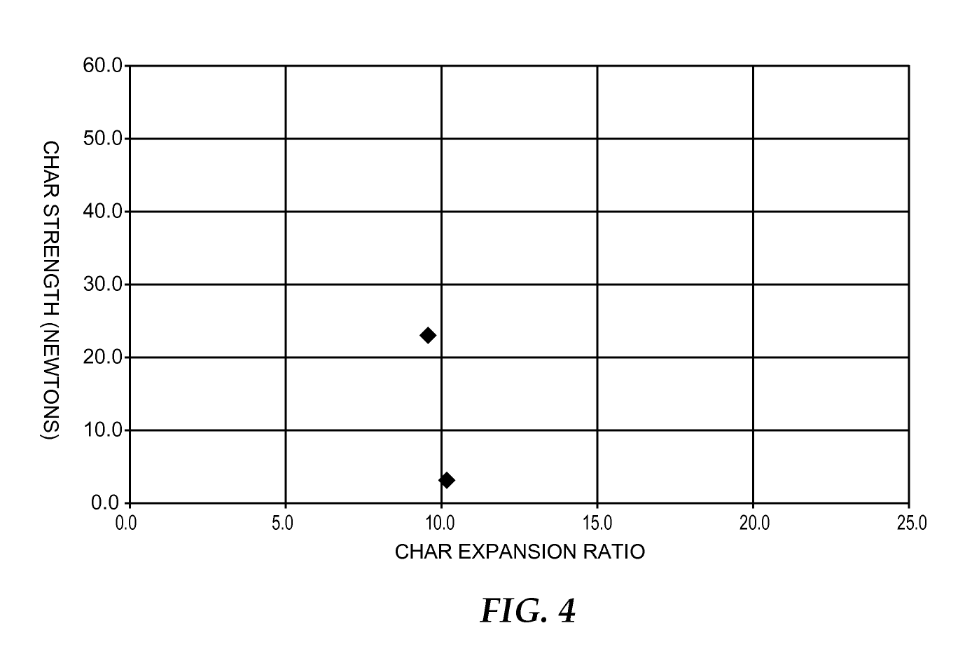

The resulting mixtures were tested according to the methods described above and found to have expansion factors and char strengths as shown in Table 8 below and in FIG. 4.

TABLE 8

| | Dry | Expanded | | Char |
|---|---|---|---|---|
| Sample | Thickness | Height | Expansion | Strength |
| ID | (mm) | (mm) | Ratio | (N) |
| X | 6.8 | 65 | 9.6 | 23.0 |
| Y | 6.1 | 62 | 10.2 | 3.2 |

### Example 5

The following ingredients (see Table 9 below) were mixed into a paddle-type mixer (Kitchen Aid standard mixer) with continuous mixing for about 20 minutes at room temperature. The remainder of the composition was the latex binder stock composition referenced above. It was observed that the presence of the nanosilica allowed the EDAP1 to mix in more uniformly.

TABLE 9

| Sample | | Nanosilica | |
|---|---|---|---|
| ID | EDAP1 | (5 nm) | Graphite3 |
| AA | 29.7% | 0.3% | 15% |
| BB | 30% | 0% | 15% |

The resulting mixtures were tested for expansion. It was observed that Sample ID AA (including 0.3 wt. % nanosilica) had higher expansion than Sample ID BB.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

### Further Embodiments

In various embodiments, an intumescent caulking composition is included. The composition can include a nitrogen phosphorus component; and a expandable graphite. The composition can exhibit a char expansion ratio of at least 8; a char strength of at least 8 N; and a caulk rate of greater than 100 gm/min after 1 day. In various of these embodiments, the nitrogen phosphorus component can include ethylene diamine phosphate. In various of these embodiments, the composition can exhibit a char expansion ratio of at least 10. In various of these embodiments, the composition can exhibit a char strength of at least 10 N. In various of these embodiments, the composition can exhibit a caulk rate of greater than 200 gm/min after 1 day. In various of these embodiments, the composition can exhibit a caulk rate of greater than 300 gm/min after 1 day. In various of these embodiments, the composition can include at least about 5 wt. % of the nitrogen phosphorus component. In various of these embodiments, the composition can include from about 5 wt. % to about 45 wt. % of the nitrogen phosphorus component. In various of these embodiments, the composition includes at least about 10 wt. % of the nitrogen phosphorus component. In various of these embodiments, the composition includes at least about 5 wt. % of the expandable graphite. In various of these embodiments, the composition includes from about 5 wt. % to about 45 wt. % of the expandable graphite. In various of these embodiments, the composition includes at least about 10 wt. % of the expandable graphite. In various of these embodiments, the composition includes at least about 15 wt. % of an elastomeric binder. In various of these embodiments, the elastomeric binder includes an aqueous solvent. In various of these embodiments, the elastomeric binder includes a latex binder. In various of these embodiments, the composition includes at least about 30 wt. % of an elastomeric binder. In various of these embodiments, the composition includes a silica material. In various of these embodiments, the silica material can be a nanosilica. In various of these embodiments, the composition includes from about 0.01 wt. % to about 8.0 wt. % of a silica material. In various of these embodiments, the composition includes from about 0.1 wt. % to about 5.0 wt. % of a silica material.

In various embodiments, an intumescent caulking composition is included. The composition can include at least about 5 wt. % ethylene diamine phosphate; at least about 5 wt. % expandable graphite; and at least about 30 wt. % of an elastomeric binder. In various of these embodiments, the composition can exhibit a char expansion ratio of at least 8. In various of these embodiments, the composition can exhibit a char expansion ratio of at least 10. In various of these embodiments, the composition can exhibit a char strength of at least 8 N. In various of these embodiments, the composition can exhibit a char strength of at least 10 N. In various of these embodiments, the composition can exhibit a caulk rate of greater than 200 gm/min after 1 day. In various of these embodiments, the composition can exhibit a caulk rate of greater than 300 gm/min after 1 day. In various of these embodiments, the composition can include from about 5 wt. % to about 45 wt. % of ethylene diamine phosphate. In various of these embodiments, the composition includes at least about 10 wt. % of ethylene diamine phosphate. In various of these embodiments, the composition includes from about 5 wt. % to about 45 wt. % of the expandable graphite. In various of these embodiments, the composition includes at least about 10 wt. % of the expandable graphite. In various of these embodiments, the elastomeric binder comprises an aqueous solvent. In various of these embodiments, the composition includes a silica material. In various of these embodiments, the silica material can be a nanosilica. In various of these embodiments, the composition can include from about 0.01 wt. % to about 8.0 wt. % of a silica material. In various of these embodiments, the composition includes from about 0.1 wt. % to about 5.0 wt. % of a silica material.

In various embodiments, a method of making an intumescent caulking composition is included. The method can include mixing together components including at least about 5 wt. % ethylene diamine phosphate, at least about 5 wt. % expandable graphite, and at least about 30 wt. % of an elastomeric binder to form the intumescent caulking composition.

In various embodiments, a method of using an intumescent caulking composition is included. The method can include applying the intumescent caulking composition to a surface. The intumescent caulking composition can include at least about 5 wt. % ethylene diamine phosphate, at least about 5 wt. % expandable graphite, and at least about 30 wt. % of an elastomeric binder. In various embodiments, the surface can include one or more sides of a through penetration. In various embodiments, the surface can include one or more sides of an aperture. In various embodiments, the surface can include a surface of a pipe.

In various embodiments, a method of enhancing the fire retardancy of a wall or floor is included. The method can include preparing an intumescent caulking composition by mixing a nitrogen phosphorus component, an expandable graphite, and an elastomeric binder together; applying the intumescent caulking composition to openings through the wall or floor; and allowing the intumescent caulking composition to dry.

What is claimed is:

1. An intumescent caulking composition comprising:
a nitrogen phosphorus component;
an expandable graphite;
the composition exhibiting:
a char expansion ratio of at least 8;
a char strength of at least 8 N; and
a caulk rate of greater than 100 gm/min after 1 day.

2. The intumescent caulking composition of claim 1, the nitrogen phosphorus component comprising ethylene diamine phosphate.

3. The intumescent caulking composition of claim 1, the composition exhibiting a char expansion ratio of at least 10.

4. The intumescent caulking composition of claim 1, the composition exhibiting a char strength of at least 10 N.

5. The intumescent caulking composition of claim 1, wherein the composition includes at least about 5 wt. % of the nitrogen phosphorus component.

6. The intumescent caulking composition of claim 1, wherein the composition includes from about 5 wt. % to about 45 wt. % of the nitrogen phosphorus component.

7. The intumescent caulking composition of claim 1, wherein the composition includes from about 5 wt. % to about 45 wt. % of the expandable graphite.

8. The intumescent caulking composition of claim 1, further comprising at least about 15 wt. % of an elastomeric binder.

9. The intumescent caulking composition of claim 1, the elastomeric binder comprising an aqueous solvent.

10. The intumescent caulking composition of claim 1, further comprising from about 0.01 wt. % to about 8.0 wt. % of a silica material.

11. An intumescent caulking composition comprising:
at least about 5 wt. % ethylene diamine phosphate;
at least about 5 wt. % expandable graphite; and
at least about 30 wt. % of an elastomeric binder.

12. The intumescent caulking composition of claim 11, the composition exhibiting a char expansion ratio of at least 8.

13. The intumescent caulking composition of claim 11, the composition exhibiting a char strength of at least 8 N.

14. The intumescent caulking composition of claim 11, wherein the composition includes from about 5 wt. % to about 45 wt. % of ethylene diamine phosphate.

15. The intumescent caulking composition of claim 11, wherein the composition includes at least about 10 wt. % of ethylene diamine phosphate.

16. The intumescent caulking composition of claim 11, wherein the composition includes from about 5 wt. % to about 45 wt. % of the expandable graphite.

17. The intumescent caulking composition of claim 11, wherein the composition includes at least about 10 wt. % of the expandable graphite.

18. The intumescent caulking composition of claim 11, the elastomeric binder comprising an aqueous solvent.

19. The intumescent caulking composition of claim 11, further comprising from about 0.01 wt. % to about 8.0 wt. % of a silica material.

20. A method of making an intumescent caulking composition comprising:
mixing together components including
at least about 5 wt. % ethylene diamine phosphate;
at least about 5 wt. % expandable graphite; and
at least about 30 wt. % of an elastomeric binder to form the intumescent caulking composition.
